(19) United States
(12) Patent Application Publication
(10) Pub. No.: US 2005/0060636 A1
(43) Pub. Date: Mar. 17, 2005

(54) Digital photo album

(76) Inventor: Zsolt Mathe, Sammamish, WA (US)

Correspondence Address: ZSOLT MATHE, 592 241ST LANE SE, SAMMAMISH, WA, 98074, US

(21) Appl. No.: 10/661,440

(22) Filed: Sep. 15, 2003

(51) Int. Cl. G06F 17/00

(52) U.S. Cl. 715/500

(57) ABSTRACT

The Digital Photo Album stores digital JPEG images and animations downloaded from a digital camera, computer or Internet on internal storage. It allows viewing, organizing and presenting of the stored pictures. It comprises of a color LCD display, USB port, Compact Flash Card™ port and simple control buttons to browse pictures. A central mini-computer performs processing on user input, USB communications, Flash card IO and display control.

### CROSS-REFRENCE TO RELATED APPLICATIONS

Applications relating to the areas of:
Computer and computing discovery
Liquid crystal display invention
Flash memory invention

### STATEMENT REGARDING FEDERALLY SPONSORED RESEARCH OR DEVELOPMENT

Not Applicable

### BACKGROUND OF THE INVENTION

Digital photography has the disadvantage that viewing and transmission of the pictures is costly, slow and cumbersome. Currently digital images are stored on computers or are printed. To download images to the computer takes time and they are not easy to transfer to other people. To print images using a printer, it costs much more (4 to 6 times) than to develop photographic film. Overall, these difficulties hold digital photography back to people who like to have a simple and inexpensive solution to sharing and organizing digital pictures.

### BRIEF SUMMARY OF THE INVENTION

The Digital Photo Album is a portable device that allows permanent storage, retrieval, organization and presentation of digital pictures and short animations acquired from a digital camera, computer or the Internet. Transferring pictures from the camera is as simple as removing the flash card from the camera, putting it into the digital photo album and pressing a button. Also any picture on a computer can be stored in the digital photo album. Through the Internet, long distance picture sharing can be made seamless. It can also be used as a picture frame by enabling presentation mode, which displays a slide show of pictures. It solves the problem of printing pictures by reducing cost, and it is much faster and easier to learn to use than a computer.

The device consists of a LCD display and three buttons for browsing and setup. Internally a central computer performs the image decoding, storage and USB communications with an external computer (if any) or external Compact Flash Card™ access. An internal rechargeable battery keeps the device operating when no electrical power is present.

### BRIEF DESCRIPTION OF SEVERAL VIEWS OF THE DRAWING

FIG. 1. Example view of a digital photo album with one LCD screen and cover.

FIG. 2. Example view of a digital photo album with two LCD screens on both covers.

FIG. 3. Internal block diagram and description of components.

### DETAILED DESCRIPTION OF THE INVENTION

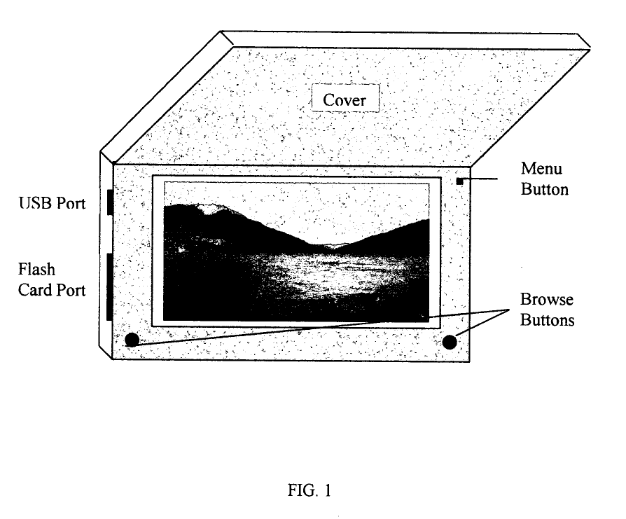

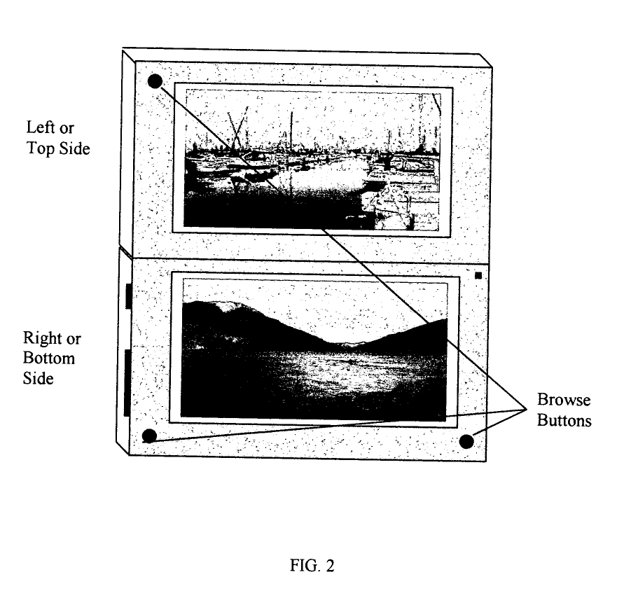

The digital photo album stores the pictures or animations in a internal flash card memory permanently. The album may come in many configurations and number of LCD screens (FIGS. 1 and 2). Any flash card from a digital camera can be used to view the pictures on, copy pictures from without the use of a computer. Also through the USB port and a personal computer, the user can save pictures to the photo album and can add text captions to each picture or animation. As the pictures are stored, they are downscaled to the album's native resolution, thus allowing up to 10 times more picture storage as compared to a digital camera with the same amount of flash storage memory. Functionality provided:
1) Browse pictures one by one by pressing the left or right browse buttons
2) Browse pictures quickly by holding down the left or right browse button. In this case the display will show a matrix of 12 pictures, and a page bar that shows how “deep” in the album is the user looking.
3) Zoom in by holding both buttons down. Once both buttons are held, the picture zooms in 2×. At this point the buttons can be used to move the zoom window through the picture. Holding both buttons down again reverts back to normal mode.
4) If an animation is shown at the current position, it plays once. If both buttons are held, it plays again.
5) If the menu button is pressed, a menu is displayed on the screen with the following options (other options may be needed, and some of these options may not be needed for different configurations of the album):
   a. Presentation Mode [On/Off]
   b. Presentation Interval [# min]
   c. Present Current Picture Only [Yes/No]
   d. Presentation Order [Random/Sequential]
   e. Presentation Cross Fade [None, Fast, Medium, Slow]
   f. Browse Cross Fade [None, Fast, Medium, Slow]
   g. Sleep Time [# min]
   h. Exit Menu

Each time the user presses the menu button, the possible values change for the selected menu item. Pressing the left and right browse buttons changes the selected menu item.

The presentation option allows the album to be used as a picture frame. According to the settings, in presentation mode the pictures or animations are shown in some order with a set interval. The cross fade option sets how fast the cross fades happen. Sleep time sets how long should the album stay on after no motion has been detected.

There may be functionality that is provided to control the price:
1) Sleep motion sensor vs. time based sleep.
2) Ability to playback animations without sound
3) One or two screen models
4) Screen size
5) Ability to wirelessly connect to the internet through Ethernet
6) Ability to wirelessly connect to other digital photo albums through wireless USB

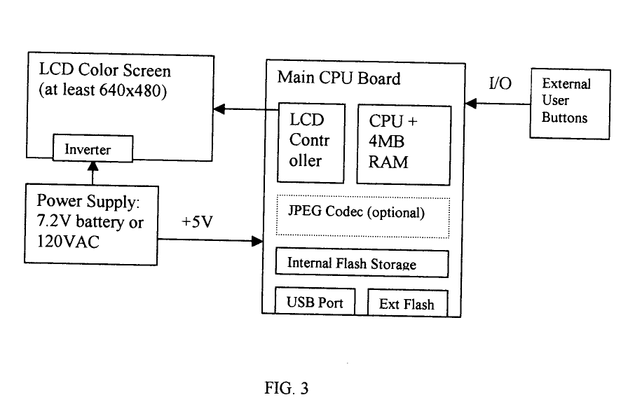

The LCD screen is a TFT type, cathode tube illuminated device. Its resolution should be at least 640×480 pixels and at least 6 bits per color (total of 18 bits). The main controller board is a single board computer, with LCD video output with 2 MB video memory (FIG. 3). The CPU should have at least 25 Mhz clock speed if separate JPEG processing chip is used. If the coding/decoding is done through software, the CPU must be running at a 50 Mhz CPU clock speed at least. A minimum of 2 MB or RAM is required. The external user buttons are connected through I/O ports to the CPU. The internal flash memory of Compact Flash™ type stores all the pictures, animations and it contains the embedded operating system with the control software. The internal flash memory is upgradeable. The driving software is not CPU dependent, although for most compatibility and versatility, an X86 CPU should be used with an embedded operating system such as Embedded DOS, Embedded Windows or Embedded Linux. The driving/control software is responsible to communicate to both flash devices, communicate to the USB port, optionally encode and decode JPEG images, read input from the I/O inputs connected to external buttons and display images on the LCD panel. Once the album is powered up, the software will search for the presence of an external flash card, if one is present, it displays pictures from it and allows the user to transfer pictures from it to the internal flash storage of the album. If an external flash card is not present (not plugged in), the digital photo album displays the internally stored pictures. In this mode it also allows the user to manage the pictures by moving and deleting them.

The power supplied to the device must be regulated to +5V DC. This will be achieved from a rechargeable battery of at least 2 Ah and at least 7.2V assuming that the CPU board and LCD display will consume 15-20 W. The album has a connector for a power cord to be used for presentation mode or to charge the battery.

Bundled computer software for PCs allows the user to upload, download and add text captions to pictures stored on the flash card in the album through the USB interface. It also allows the user to change all functionality provided through the on screen menu. The software allows conversion from the most popular picture formats to JPEG for easy uploading to the album. Through an Internet service, users can buy still or animated artwork for the album as well as interchange pictures between friends that automatically get transferred to the digital photo album. In order to protect the artwork from copying, the process of downloading the artwork to the device is as follows: With the device connected the user creates an account on the artwork site. The device's unique key is sent to the website. When the artwork is downloaded, its encrypted with this unique key and thus it can be only read by one device. The user has the option of adding more albums to the account, but each purchase of an artwork is coded for a single album.

Wireless options can be added to the digital photo album to enhance and expand picture storage capabilities. One of these options is to include a wireless Ethernet module in the digital photo album that connects to a base station. The base station would be connected to the Internet through a cable. This way the album can directly communicate with a website to allow anyone around the world who to owner of the album gives permission to manage, store and retrieve pictures from it. This can also be implement through connecting the album to a computer, but it would not be as seamless and as easy to administer as the wireless solution. Another option that can be applied in parallel with the wireless Ethernet is to include a wireless USB communication module in the digital photo album and a wireless USB hub. This would allow control of all the digital photo albums in a radius from any digital photo album or from a computer. This method would allow a faster and easier way to organize pictures in every location where there is a digital photo album in the area. This is different than wireless Ethernet in a sense that no Internet connectivity is required. Both wireless options would have a RF range of a few hundred feet on average.

The internal software is the most important part of the digital photo album. Here will be presented the source code in simple pseudo code format similar to C and C++:

```
main( )
{
      InitializeLCD( );
      If(Compact Card Present)
            ReadPictureNames(CompactCard);
      Else
            ReadPictureNames(LocalStorage);
      // main loop
      while(not done)
      {
            PerformUSBCommunications( );
            PerformEthernetCommunications( );
            If(Forward Button Pressed) NextPictureorMenuItem( );
            If(Backward Button Pressed)
            PreviousPictureorMenuItem( );
            If(Menu Button Pressed) ToggleMenuDisplay( );
            If(Menu is Displayed) ProcessSelectedMenuOptions( );
            If(Picture has changed) LoadPicture(CurrentPictureName);
            If(Animation)
            {
                  Delay( );
                  CurrentPictureName = NextAnimationFrame( );
            }
            DrawCurrentPicturetoLCD( );
      }
}
PerformUSBCommunication( )
{
      if(Received USB Command)
      {
            // perform actions directed by the computer
            switch(USB Command)
            {
                  case Send Picture
                        LoadPicture( );
                        SendPictureBytes( );
                  case Receive Picture
                        ReceivePictureBytes( );
                        SavePicture( );
                  case Delete Picture
                        if(Compact Card Not Present)
                              DeleteFile(Picture Name);
                  case Retreive List of Pictures
                        Send(ReadPictureNames(StorageSource));
                  case Set Picture Text
                  case Perform Menu Command
                        ProcessSelectedMenuOptions( );
            }
      }
}
PerformEthernetCommunications( )
{
      CheckInternetSiteForPictures( );
      If(Pictures need to be downloaded)
            DownloadPictures( );
      If(Pictures need to be uploaded)
            UploadPictures( );
}
ProcessSelectedMenuOptions( )
{
      // perform actions directed by the user
      switch(Current Menu Option)
      {
            case Copy Pictures from external Flash
                  while(Not Done)
                        Copy(Local Storage, Flash Card);
            case Delete picture(s)
                  if(Compact Card Not Present)
                        DeleteFile(Picture Name);
            case Enable Presentation Mode
                  TogglePresentationTimer( );
            case Picture Transition speed
                  SetPictureTransitionSpeed( );
      }
}
LoadPicture(PictureName)
{
      ReadFile(PictureName);
      DecodeJPEG( );
}
SavePicture(PictureName)
{
      EncodeJPEG( );
      SaveFile(PictureName);
}
```

The above code sample illustrates the basic program flow. Any hardware specific details and language specific details are omitted. The program consists of a main loop that listens to the user button inputs, checks for any response from a connected computer through USB or Ethernet and draws the pictures to the video buffer memory of the LCD. The local pictures are stored on the local flash memory card, which is a file system to the program, thus each image is a JPEG file. Also if an external flash card is plugged in, it acts as file system from which JPEGs are read. Because it is unknown in what format different digital cameras store pictures (other than that it is JPEG), the external flash file system needs to be recursively searched for all JPEG images. The animations can be stored as an MPEG movie or as a series of JPEG images, most likely the MPEG option will give the best compression.

Altogether the device would be appealing to novice and expert digital photographers, and anyone who views pictures potentially making it a very popular household item next to the digital camera.

1. A portable device, a digital photo album that digitally stores JPEG pictures, JPEG picture series animations without sound on an internal flash storage card of any capacity for later viewing on a built-in color LCD flat display panel. Viewing is performed by user command through external buttons or automatically by elapsed time interval. The internal CPU controls the USB communications chip, external flash card reader by which pictures can be transferred from any digital camera, input from user accessible buttons and image display on the LCD panel through a stored program. The power is supplied through rechargeable battery or AC outlet.

2. A digital photo album as claimed in claim 1, where there are two LCD display panels organized such that they are on each side of a flippable cover.

3. A digital photo album as claimed in claim 1, containing a wireless Ethernet connection kit and a wireless Ethernet hub for communications through the Internet and computers in a radius of the order of 100 meters.

4. A digital photo album as claimed in claim 1, containing a wireless USB communications component for communications with other digital photo albums and computers in a radius of the order of 100 meters.

5. A digital photo album as claimed in claim 1, where computer connectivity is performed by any other means than USB technology.

6. A digital photo album as claimed in claim 1, where a digital camera can be directly connected to the digital photo album to transfer pictures taken with the camera.

7. A digital photo album as claimed in any combination of claims 1, 2, 3, 4, 5 and 6.
